(19) United States
(12) Patent Application Publication
(10) Pub. No.: US 2018/0258506 A1
(43) Pub. Date: Sep. 13, 2018

(54) HEAT TREATMENT SYSTEM

(71) Applicant: SCHWARTZ GMBH, Simmerath (DE)

(72) Inventors: Jörg WINKEL, Nideggen-Schmidt (DE); Frank WILDEN, Simmerath (DE)

(21) Appl. No.: 15/759,875

(22) PCT Filed: Sep. 12, 2016
(86) PCT No.: PCT/EP2016/071450

§ 371 Date: Mar. 14, 2018

(30) Foreign Application Priority Data
Sep. 18, 2015 (EP) 15185974.1

(51) Int. Cl. C21D 9/00; C21D 9/46; F27B 9/24; F27D 5/00

(52) U.S. Cl. CPC C21D 9/0056; F27D 5/00; F27B 9/2407; C21D 9/46

(57) ABSTRACT

The invention relates to a heat treatment system, in particular a roller hearth furnace. The heat treatment system comprises a useful space having a first area with a width B1 and a second area with a width B2, wherein the rollers are arranged in the first area, and wherein width B2 is greater than width B1. In this context, “width” is understood to be the dimension that is transverse to the through-flow direction of the furnace. Width B1 is thereby measured such that the rollers have a length at which, even when there is a temperature in the furnace for the heat treatment of metal components, they still have such a mechanical stability, for example, that their bending remains within acceptable tolerances, even in the loaded state. The second area of the useful space extends above the first area of the useful space, with the greater width B2, such that components with a maximum width B2, greater than width B1, can also be heat treated.

The invention relates to a heat treatment system, in particular a roller hearth furnace.

It is the aim within the vehicle manufacturing industry to develop vehicles that consume as little fuel as possible. A common means of reducing the fuel consumption is to reduce the weight of the vehicle for example. In order to meet the increasing safety requirements, however, the structural steel used in the chassis needs to have greater stability but less weight. This is usually achieved by employing the so-called press hardening method. This entails heating the sheet metal component to approximately 800-1,000° C. and then subsequently forging and hardening in a cooled tool. The stability is increased by up to three-fold with this method.

For processing safety reasons and due to the economic efficiency, the roller hearth furnace has been the one to establish itself for carrying out the heat treatment. This involves the metal components being processed being continuously conveyed through the furnace.

In the case of press hardening, there is a fundamental difference made between the direct and the indirect method.

The indirect method entails a plate being punched out of a coil, cold-forged and the preformed component being forwarded to the heat treatment. Following the heat treatment, the hot component is forwarded to the press in an indirectly cooled tool and press-hardened. The components are then subsequently trimmed and sand-blasted to remove any possible scaling that may be present. In the case of the direct method, a plate is also punched out of the coil, but no preforming takes place here, the plate is instead conveyed directly into the furnace while still hot following the heat treatment. In an indirect, for example water-cooled tool, the hot plate is forged and concurrently press-hardened in a cooled tool. Subsequently, the formed components are trimmed as required.

The so-called roller hearth furnaces have been the ones to establish themselves due to processing safety reasons and due to the economic efficiency in the case of both methods. Roller hearth furnaces are continuous furnaces, in whose case the components to be processed are either conveyed through the furnace directly on rollers or on goods carriers on rollers. The rollers are usually driven.

Because the components are preformed using the indirect method, they have to be conveyed through the furnace on goods carriers or brought into the furnace chamber. Continuous furnaces can furthermore be equipped with an inflow and outflow sluice for this method. In order to avoid a scaling of the component surface, such a furnace can be operated using inert gas. The inflow and outflow sluice are for preventing air from entering the furnace, which usually entails a rinsing or exchange of the atmosphere in the sluices. The sluices furthermore prevent the atmosphere inside the furnace from escaping into the surrounding area and this prevents a loss of heat into the surrounding area. Continuous furnaces for this method must be equipped with a goods-carrying return system in order to ensure the circulation of the goods carriers. Ceramic rollers should be used in the furnaces for example. Only the inflow and outflow tables, as well as the goods carrier return system are equipped with metal conveyer rollers in this case. Depending on the application case, it is possible that the conveyer rollers are made of other materials.

In the case of continuous furnaces for the direct method, the use of goods carriers does not apply. This means that the construction is simpler compared with the continuous furnaces for the indirect method. Instead of being conveyed using goods carriers, in the case of the direct method, the plates can be placed directly onto the ceramic conveyer rollers and conveyed through the furnace. These furnaces can be operated with or without inert gas. The furnace housing in this case is also designed to be gas tight as standard. A further benefit offered by this embodiment is the positive effect on the conveyer roller on the uniform heating of the metal components to be processed: The fixed rollers that are heated by the furnace heating also heat the metal component being transported on them, and which is thus in direct contact with them, through radiation and conduction. Furthermore, these furnaces can be operated with a far lower power input being required because there are no goods carriers that could cool out during the return transport after being conveyed through the furnace and, as a result, does not need to be heated up once again when it is conveyed through the furnace the next time. The direct method is therefore preferred when using continuous furnaces.

The metal plates used in vehicle manufacturing should be as rust-proof as possible. A scaling during the processing should also be avoided because the scaling would then need to be expensively and time consumingly removed before undergoing further processing, at the latest prior to the welding and painting methods. Because untreated steel plates would inevitably become scaled at the high temperatures required for press hardening if oxygen was present, it is customary to use coated plates and/or carry out the heat treatment method when no oxygen is present. Aluminum-silicon (AlSi) coated plates can be used for this for example. Other coatings such as, for example, zinc-alloy coatings and zinc-nickel coatings are also possible. The coating prevents the plates from rusting, as well as scaling of the hot plates during the transfer from the furnace to the press.

The furnace can be heated in different ways. Most commonly they are heated using burners, which are operated using fossil fuels, such as gas. Other forms of heating are also possible, such as electric radiation heating for example.

The rollers of a roller hearth furnace usually have rotatable bearings at their ends, for example, in the lateral limiting walls of the furnace. Problems arise in relation to constructing the conveyer roller bearings to allow for long and economically feasible maintenance intervals due to the high temperatures that exist in the furnace and the at time aggressive gases present in the furnace atmosphere. Solution suggestions such as gas tight and cooled bearings in the furnace walls are known, for example, from the German published patent application DE10 2011 006 171 A1.

A further problem is posed by the mechanical stability of the rollers due to the limited width of the roller hearth furnace, particularly regarding the effect of the high temperatures in the roller hearth furnace required for the heat treatment of metallic components, such as during the press hardening method. It is for this reason that currently customary roller hearth furnaces have a maximum inner width of approximately 2.70 meters, this means that a component to be heat treated in this roller hearth furnace may not be more than approximately 2,500 mm in one direction, the width direction.

The object of the invention is therefore to provide a heat treatment system for heat treating metal components that have a wider effective working width.

According to the invention, this object will be carried out by the heat treatment system with the characteristics of the independent claim 1. Beneficial advancements of the heat treatment system result from the subclaims 2-9.

According to the invention, the heat treatment system consists of rollers for conveying a component to be heat treated through the heat treatment system. This can entail the component constituting a steel material, for example 22MnB5, and being coated or uncoated. As coating, aluminum-silicon (AlSi) coatings, zinc alloy coatings, such as zinc-nickel coatings, or a scaling-protection paint can be considered. The heat treatment system according to the invention comprises a useful space having a first area with a width B1 and a second area with a width B2, wherein the rollers are arranged in the first area, and wherein width B2 is greater than width B1. In this context, “width” is understood to be the dimension that is transverse to the through-flow direction of the furnace. Width B1 is thereby measured such that the rollers have a length at which, even when a temperature exists in the furnace for the heat treatment of metal components, they still have such a mechanical stability, for example, that their bending remains within acceptable tolerances, even in the loaded state. The second area of the useful space extends above the first area of the useful space, with the greater width B2, such that components with a maximum width B2, greater than width B1, can also be heat treated. The first area with the rollers is therefore arranged in the lower area of the useful space so that a component can directly lie on, or when on a goods carrier, lie on at least one roller and be transported through the heat treatment system. In other words, the heat treatment system according to the invention consists of a graduated useful space width so that, on the one hand, the criteria due to the mechanical stability of the limited roller length, and on the other hand, the criteria for the heat treatment of a wider component are also fulfilled. It is a benefit when the heat treatment system consists of several heat sources in the second area of the useful space, wherein the several heat sources are arranged one after another in the furnace through-flow direction.

In a beneficial further development, the heat treatment system furthermore consists of a goods carrier, wherein the goods carrier consists of a first and a second area with a width W1 and a third area with a width W2, wherein the width W1 is smaller than the width B1 of the area of the useful space and the width W2 is smaller than the width B2 of the second area of useful room and wherein the goods carrier with its first area is in contact with at least one of the rollers. The goods carrier also consists of, in other words, a graduated profile, wherein with the second, wider area of the goods carrier, components that are wider than the width B1 of the first useful space area can be carried.

It has been shown to be beneficial if the second area of the goods carrier serves the purpose of height adjustment and the third area of the goods carrier is designed to be a put down location for the component. The term height adjustment in this case means the compensation of the different distances of the work level of the heat treatment system, meaning the level of the upper circumference line of the rollers, and the level in which the useful space widens compared, for example, with the floor of the industrial building on which the heat treatment system is set up. The useful space of the heat treatment system widens in its second area compared to the first area, wherein the second area is arranged above the first area. It proved in particular to be a benefit when the third area of the goods carrier, that comes into contact with the component during operation, contains a ceramic material. The first area of the goods carrier rests on at least one roller of the heat treatment system during operation.

In a second beneficial embodiment, the heat treatment system consists of at least one heat source in the first area in addition to several heat sources in the second area of the useful space. The at least one heat source arranged in the first area of the useful space can, for example, be arranged underneath the rollers. This arrangement of at least one heat source in the first and in the second area of the useful space ensures that the component to be heat treated is heated from both sides, this means from above and from underneath, wherein a particularly fast and homogenous heating of the component is carried out.

In a further beneficial embodiment, gas burners with flame pipes are foreseen as a heat source. Gas burners are characterized by their energy efficiency. In addition to this, a gas infrastructure is usually present in the production facilities for the heat treatment of metallic components. All other heat sources, such as electric radiation heat sources are also possible for example.

A further beneficial embodiment is when several heat sources are arranged in the second area of the useful space, wherein the several heat sources are arranged one behind the other in the furnace through-flow direction and alternatingly protrude from the lateral limiting walls of the useful space into the second area of the useful space. The burners usually use fossil fuels in the flame pipes, in which the flames burn. This embodiment allows the flame pipes to have a shorter length despite the possible large width B2 of the second area of the useful space, so that a bending or a one-sided bending effect does not reach a critical dimension, while nevertheless allowing for a homogenous heating of the component across the entire width of the component.

It has furthermore proven beneficial when at least one roller is made of a ceramic material. It is particularly beneficial when all rollers in the useful space are made of a ceramic material and only when the rollers in the inflow and outflow zones, in which lower temperatures exist than in the useful space of the furnace when it is in operation, are made from a different material, such as steel for example. If the roller consists of a ceramic material, these could be more resistant to high temperatures than steel rollers.

In a beneficial embodiment, the heat treatment system consists of an inflow and outflow sluice. The sluices also mean that the furnace operation is also possible for significantly curved pre-formed components to also undergo the indirect method with inert gas, without any of the inert gas escaping into the surrounding atmosphere. On the one hand, inert gas escaping into the surrounding atmosphere could have damaging health consequences for any operating personnel in the proximity who are possibly exposed to it, on the other hand, the customary inert gasses are relatively expensive which means that any escape of the inert gas could have negative economic consequences. The furnace atmosphere can also contain dried air whose escape could also have negative economic consequences. In addition to this, the sluices can minimize the heat loss of the heat treatment system by minimizing the exchange of atmosphere between the heat treatment system and the surrounding area. If the heat treatment system should, on the other hand, be operated with an air atmosphere for flat plates or preformed components, for example, the sluices do not interfere.

The heat treatment system according to the invention, is suitable for processing plates on goods carriers in the direct method, which are processed in the second, wider area of the useful space. The heat treatment system is, however, also equally suitable to heat treat preformed components on goods carriers in the indirect method in the second wider area of the useful space.

Furthermore, both plates on goods carriers in the direct method and preformed components on goods carriers in the indirect method can be processed. This can involve processing the plates or preformed components, even if they do not protrude over the width B1 of the first useful space area, in the second wider area of the useful space or also in the first, narrower area of the useful space. If the components in the first area of the useful space are to be processed, an alternative goods carrier must be used, in whose case at least the second area is missing or is too short for the height adjustment. This can have a third area for putting down the component, for example produced from a ceramic material, wherein in this case this third area has a width that is smaller than the first area of the useful space B1. The components in this case can also be laid directly on top of the first area of the goods carrier.

The heat treatment system according to the invention can ultimately also be used to directly lay plates onto the rollers without any goods carrier and to process these in the direct method.

Further benefits, particularities and purposeful further embodiments of the invention arise from the subclaims and the subsequent illustration of an embodiment example using the figure.

### FIGURES

FIG. 1 shows a cross-section of a heat treatment system according to the invention.

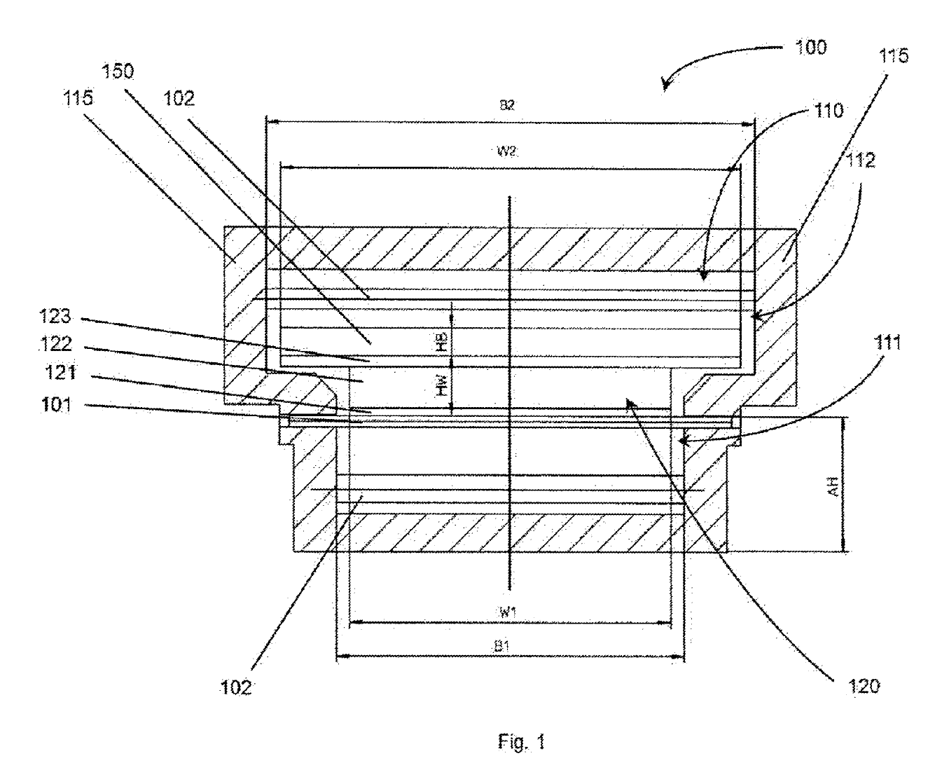

In FIG. 1 a cross-section of a heat treatment system 100 according to the invention is shown. The heat treatment system 100 consists of rollers 101 for the through flow of a component 150 to be heat treated by the heat treatment system. Furthermore, the heat treatment system 100 consists of a useful space 110 with a first area 111 with a Width B1 and a second area 112 with a width B2, wherein the roller 101 is arranged in the first area 111 and wherein the width B2 is larger than width B1. Width B1 can, for example, be 2,500 mm, while width B2, for example, can be 3,500 mm. The heat treatment system 100 furthermore consists of a goods carrier 120, wherein the goods carrier 120 consists of a first area 121 and a second area 122 with a width W1 and a third area 123 with a width W2, wherein width W1 is smaller than width B1 of the first area 111 of the useful space 110 and a width W2 smaller than width B2 of the second area 112 of the useful space 110 and wherein the goods carrier 120 is in contact with at least one of the rollers 101 with its second area 121. The second area 122 is for the purpose of the height adjustment and the third area 123 of the system is to produce the component 150. In total, the heights of the three areas 121, 122, 123 add up to the height of the goods carrier HW, which can be 420 mm for example. On the third area 123 of the goods carrier 120, a preformed component lies as component 150, which has the thickness HB of 200 mm for example. The goods carrier 120 consists of a first area 121, with which the goods carrier 120 is in contact with at least one roller 101, a second area 122 for height adjustment and a third area 123 for laying the component 150 on top. The heat treatment system 100 has a working height AH, for example, of 1,150 mm. In this case, working height is to be understood as the height of the upper circumference line of the rollers 101, this means the height at which the goods carrier 120 or the component 150 go through the heat treatment system 100 during operation without goods carrier 120, measured on the basis of a production building floor, for example, on which the heat treatment system 100 is set up.

The heat treatment system 100 consists of heat sources 102 in the form of gas burners with flame pipes in the first area 111 as well as in the second area 112 of the useful space 110. This arrangement allows for a homogenous heating of the component 150 through heat input from above and from underneath. The gas burner in the second area 112 of the useful space 110 are arranged one after another in the furnace through flow direction and alternatingly protrude from the lateral limiting walls 115 of the useful space into the second area of the useful space 110.

This means that the heat treatment system 100 consists of a graduated useful space width B1 and B2. This means that the heat treatment system 100 is suitable for the processing of components 150 in the form of plates on goods carriers 120 in the direct method, which are processed in the second, wider area 112 of the useful space 110. The heat treatment system 100 is equally suitable for heat treating components 150 in the form of preformed components on goods carriers 120 in the indirect method in the second, wider area 112 of the useful space 110. Furthermore, components 150 in the form of plates as well as in the form of preformed components, that do not have a width greater than the width B1 of the first useful space area 111, can be processed on goods carriers 120 in the second, wider area 112 of the useful space 110, or also in the first, narrower area 111 of the useful space 110. If the components 150 in the first area 111 are processed, an alternative goods carrier 120, in whose case at least the second area 122 for the height adjustment is absent or has been executed too short, has to be used. This can consist of a third area 123 for laying the component 150 made of a ceramic material, wherein in this case this third area 123 consists of a width that is smaller than width B1 of the first area 111 of the useful space 110. The components 150 in this case could also be laid directly onto the first area 121 of the goods carrier 120.

Ultimately the heat treatment system 100 can also be used to directly lay the components 150 in the form of plates on the rollers 101 without goods carriers 120 in the first area 111 of the useful space 110 and to process them there employing the direct method.

The embodiments displayed here only provide examples for the invention in question here and, for that reason, may not be understood as restrictive. Alternative embodiments taken into consideration by the expert are equally included in the protective area of the present invention here.

### REFERENCE SIGN LIST

100 heat treatment system

101 roller

102 heat source

110 useful space

111 first area of useful space

112 second area of useful space

115 lateral limitation wall

120 goods carrier

121 first area of goods carrier

122 second area of goods carrier

123 third area of goods carrier

150 component

B1 width of the first area of the useful space

B2 width of the second area of the useful space

HB component height

HW goods carrier height

W1 width of the first area of the goods carrier

W2 width of the second area of the goods carrier

1. A heat treatment system, comprising rollers for the through flow of a component through the heat treatment system, characterized in that the heat treatment system comprises a useful space with a first area with a width B1 and a second area with a width B2, wherein in the first area the rollers are arranged and wherein the width B2 is larger than the width B1, wherein several heat sources are arranged in the second area of the useful space of the heat treatment system, wherein the several heat sources are arranged one after another in the furnace through flow direction.

2. The heat treatment system according to claim 1, characterized in that the heat treatment system comprises a goods carrier, wherein the goods carrier includes a first area and a second area with a width W1 and a third area with a width W2, wherein the width W1 is smaller than the width B1 of the first area of the useful space and the width W2 is smaller than the width B2 of the second area of the useful space and wherein the first area of the goods carrier is in contact with at least one of the rollers.

3. The heat treatment system according to claim 2, characterized in that the goods carrier comprises a first area with which the goods carrier is in contact with at least one roller, a second area for height adjustment and a third area for laying the component.

4. The heat treatment system according to claim 3, characterized in that the third area of the goods carrier contains ceramic materials.

5. The heat treatment system according to claim 1, characterized in that the heat treatment system further comprises at least one heat source in the first area.

6. The heat treatment system according to claim 5, characterized in that the heat source is a gas burner with flame pipes.

7. The heat treatment system according to claim 5, characterized in that the plurality of heat sources alternatingly protrude from the lateral limiting walls of the useful space into the second area of the useful space.

8. The heat treatment system according to claim 1, characterized in that at least one roller comprises a ceramic material.

9. The heat treatment system according to claim 1, characterized in that the heat treatment system comprises an inflow and outflow sluice.
